(19) United States
(12) Patent Application Publication
(10) Pub. No.: US 2007/0006270 A1
(43) Pub. Date: Jan. 4, 2007

(54) Timely recovery for media on demand streaming

(75) Inventors: Imed Frigui, Ottawa (CA); Glenn Algie, Ottawa (CA)

Correspondence Address: WITHROW & TERRANOVA, P.L.L.C., P.O. BOX 1287, CARY, NC, 27512, US

(73) Assignee: NORTEL NETWORKS LIMITED, St. Laurent (CA)

(21) Appl. No.: 11/170,211

(22) Filed: Jun. 29, 2005

(51) Int. Cl. H04N 7/173; G06F 11/00

(52) U.S. Cl. 725/93; 725/94; 714/1; 714/2; 714/48

(57) ABSTRACT

For a media on demand (MoD) session where content is streaming from a first content server to a media agent, a server manager operates to minimize or eliminate the impact of a failure affecting the streamed content. The server manager will monitor at least the first content server, and when a failure is detected, initiate the transition from the first content server to a second content server. In particular, the server manager will directly or indirectly ensure that the media agent has sufficient information to establish another streaming session for the MoD session with the second content server. The transition is preferably facilitated in real time and within a short enough time period to eliminate or at least minimize the effect of the media ultimate presentation to the subscriber.

### FIELD OF THE INVENTION

The present invention relates to media streaming, and in particular to providing a technique to recover from a failure in a timely fashion during media on demand streaming.

### BACKGROUND OF THE INVENTION

Video on demand (VoD) is growing ever more popular. More people are taking advantage of the service, and providers are striving to make more content available to their subscribers at any given time. Providing video on demand services generally involves delivering streaming video content to a video agent from a content server over a communication network, in real time and in response to a subscriber request. The video agent may be implemented in a “set-top box,” a cable card, or like entity. As such, the video agent is either associated with or integrated in a television, video monitor, audio system, or combination thereof to facilitate presentation of video content to a subscriber in real time.

The streaming nature of VoD services is such that a significant interruption in the streaming traffic results in a service failure. These failures are highly undesirable to both subscribers and providers. The interruptions in the VoD service may occur due to failures of the content server, the video agent, or other network entity, as well as network congestion. When an interruption occurs, most existing systems require the user to interact with a video agent in order to reinitiate traffic streaming for the interrupted VoD service. Requiring the user to reinitiate the VoD service is not only cumbersome to the user, but may lead to further service interruptions. For example, if the VoD service is interrupted due to network congestion or failure of another network entity, there is a high probability that the VoD service being provided to other subscribers from the given content server has also been interrupted. The interruptions are therefore not caused by content server failures, yet hundreds or thousands of subscribers may all try to reinitiate VoD services at the same time, which will add to network congestion and could overload a fully functional content server.

Accordingly, there is a need for an effective and efficient technique to provide VoD and other media on demand (MoD) services, while minimizing the impact of service interruptions or failures on the subscribers.

### SUMMARY OF THE INVENTION

For a media on demand (MoD) session, such as a video on demand (VoD) session, where content is streaming from a first content server to a media agent, a server manager operates to minimize or eliminate the impact of a failure affecting the streamed content. The server manager will monitor at least the first content server, and when a failure is detected, initiate the transition from the first content server to a second content server. In particular, the server manager will directly or indirectly ensure that the media agent has sufficient information to establish another streaming session for the MoD session with the second content server. The information may include decryption indicia to allow the media server to decrypt the streaming content from the second content server, as well as address information. The address information may provide an address for the second content server, the location of content on the second content server, or a combination thereof. The information facilitating the transition may come directly from the server manager or indirectly from other entities, in response to instructions provided by the server manager upon detecting the failure. The transition is preferably facilitated in real time and within a short enough time period to eliminate or at least minimize the effect on the ultimate presentation of the media to the subscriber.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a communication environment according to one embodiment of the present invention.

FIG. 2 is a message flow diagram according to one embodiment of the present invention.

FIG. 3 is a block representation of a video on demand server manager according to one embodiment of the present invention.

FIG. 4 is a block representation of a video agent according to one embodiment of the present invention.

FIG. 5 is a block representation of an audio/video system according to one embodiment of the present invention.

FIG. 6 is a block representation of a conditional access subsystem according to one embodiment of the present invention.

FIG. 7 is a block representation of a middleware server according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention provides a technique for dynamically recovering from a streaming failure associated with a media on demand (MoD) session. The MoD session is one in which streaming media, including audio, video, or a combination thereof, is delivered from a first content server in real time in response to a subscriber request. The recovery technique generally involves switching from the first content server to a second content server to support the MoD session when a streaming failure occurs during the MoD session. Switching from the first content server to a second content server preferably takes place quickly enough to minimize or eliminate any interruption experienced by the subscriber. The switching process automatically configures the second content server, subscriber equipment, and any other network entities to accommodate switching from the first content server to the second content server for providing the streaming media.

Prior to delving into the details of the present invention, an overview of an exemplary MoD environment is illustrated. Notably, the description will use a video on demand (VoD) service as an exemplary MoD service, wherein VoD services will generally include audio and video components, such as those associated with various television programming, including streaming network programming, news, music videos, movies, and sports.

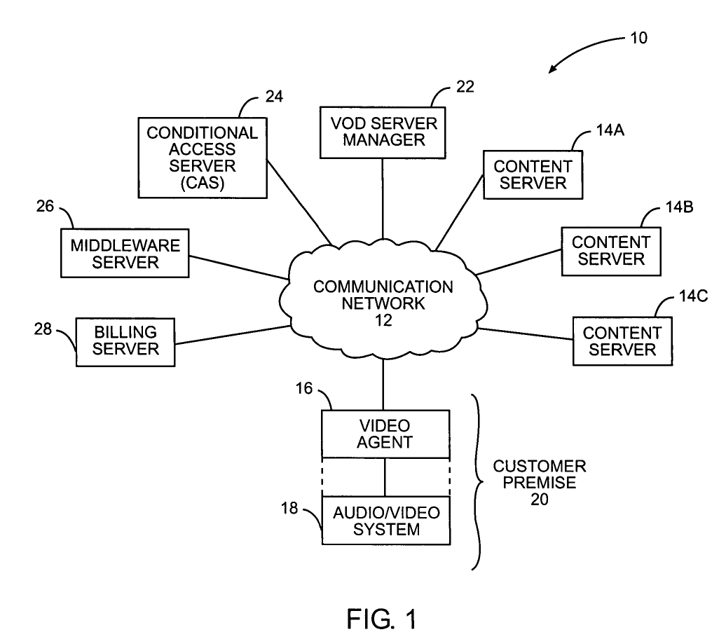

With reference to FIG. 1, a communication environment 10 is illustrated to include a communication network 12, wherein content servers 14A, 14B, and 14C are available to stream various types of media content, including video content, to an appropriate video (or media) agent 16. The video agent 16 may take numerous forms, and may be associated with or integrated into an audio/video system 18 located on the customer premises 20. For example, the audio/video agent 16 may be a set-top box, a cable card, or a logical entity running in the audio/video system 18, which in and of itself may be a television, monitor, receiver, computer, or other device capable of receiving streaming media and providing the content to the subscriber in an appropriate fashion.

The video on demand service, which again may represent any type of MoD service, may be controlled by a video on demand server manager 22, which is associated with the content servers 14A, 14B, and 14C, as well as a conditional access server (CAS) 24 and middleware server 26. The conditional access server (or subsystem) 24 primarily manages content encryption, and is used to provide or exchange the appropriate encryption or decryption keys to the video agent 16 in response to instructions from the VoD server manager 22 when a requested VoD service has been established.

The middleware server 26 is able to communicate with the video agent 16 to control program guides and the content provided in those guides, such that the subscriber can determine what programming is available and when. The middleware server 26 also plays a role in checking or ensuring the creditworthiness of the subscriber when VoD services are requested, as well as enforcing parental controls established by the subscriber. Those skilled in the art will recognize additional functions provided by the conditional access server 24 and the middleware server 26, as these entities currently exist in their basic forms.

The middleware server 26 may interact with the VoD server manager 22 and the video agent 16 to determine what programs have been ordered by the subscriber, and see if the subscriber still has sufficient credit to support the current request for a VoD service. Once a VoD service is requested, the middleware server 26 can interact with a billing server 28 to provide appropriate accounting for the services provided to the subscriber.

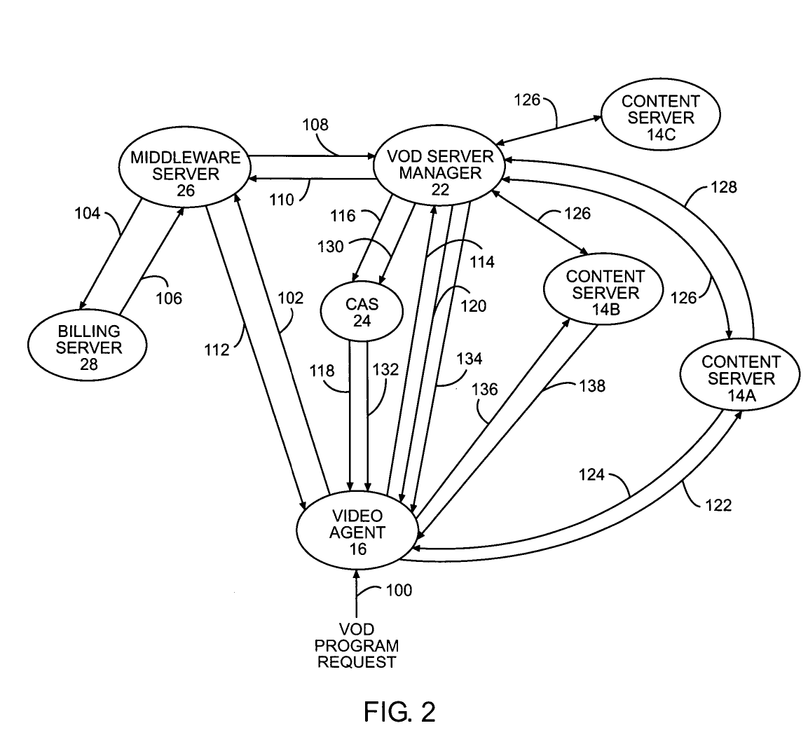

With reference to FIG. 2, a detailed communication flow is illustrated to facilitate switching from content server 14A to content server 14B when a streaming failure occurs in association with a VoD service directed to the video agent 16 as originally supported by content server 14A. The flow begins when the subscriber initiates a request for a video on demand program (step 100). The program will be associated with an identification, which will generally be referred to as Program A. Upon receiving the request for the video on demand program, the video agent 16 will place an order for Program A with the middleware server 26 (step 102). The middleware server 26 will check the creditworthiness of the subscriber by sending an appropriate query to the billing server 28 (step 104). The billing server 28 will determine whether the subscriber has sufficient credit for the requested program, and send an appropriate response back to the middleware server 26 (step 106).

Assuming the request was approved by the billing server 28, the middleware server 26 will send a query to the VoD server manager 22 to determine whether Program A is currently available for streaming (step 108). The VoD server manager 22 will recognize that Program A is available for immediate viewing, and will send an acknowledgement indicating that Program A is currently available, and information necessary for identifying the content server 14A from which the video content is streamed (step 110). The information provided by the VoD server manager 22 may also include information necessary to configure or authorize the content server 14A to provide the streaming video for Program A.

The middleware server 26 will then send the information associated with Program A to the video agent 16 (step 112). At this point, the video agent 16 will send a request for a streaming session to support Program A to the VoD server manager 22 (step 114), which will instruct the conditional access subsystem 24 to send the appropriate decryption key for Program A on content server 14A to the video agent 16 (step 116). The conditional access subsystem 24 will send the appropriate decryption key to the video agent 16 as requested (step 118).

Meanwhile, the VoD server manager 22 may send the appropriate Internet Protocol (IP) or other address associated with the location of Program A on content server 14A to the video agent 16 (step 120). Using the IP address, the video agent 16 will send a request for a session for Program A to content server 14A (step 122), which will begin streaming video (and audio) corresponding to Program A to the video agent 16 (step 124), which will interact with the audio/video system 18 (not shown in FIG. 2) to properly provide the audio and/or video content to the subscriber.

On a continuous basis, or when a VoD session is in progress, the VoD server manager 22 will monitor the status of the various content servers 14 or other network entities. The monitoring may take place on a periodic basis, and may be implemented by having the VoD server manager 24 poll the various content servers 14 as well as by having active content servers 14 provide status information at systematic time intervals (steps 126). The implementation of the polling may take many forms. Assume at some point during the VoD session being provided by content server 14A to the video agent 16 that the monitoring process results in the VoD server manager 22 detecting that content server 14A has failed or is about to fail (step 128). Upon detection of the failure or imminent failure, the VoD server manager 22 will initiate a switching process, such that the VoD service will be provided by another one of the content servers 14. The VoD server manager 22 will have information bearing on the availability and capability of the various content servers 14, and will be able to make the decision as to which content server 14B or 14C the VoD service should be switched. In this instance, assume the switching process will take place from content server 14A to content server 14B.

Upon selecting content server 14B, the VoD server manager 22 will instruct the conditional access subsystem 24 to send an appropriate decryption key for Program A on content server 14B to the video agent 16 (step 130). As instructed, the conditional access subsystem 24 will send the appropriate decryption key for Program A on content server 14B to the video agent 16 (step 132). The VoD server manager 22 will then send a message to the video agent 16 indicating that content server 14A is failing or has failed (step 134). The message will include the IP address associated with the location of Program A on content server 14B. The video agent 16 will quickly send a request for a session for Program A to content server 14B (step 136). The request may include or be associated with information indicative of where within Program A failure occurred, such that content server 14B can begin streaming approximately where content server 14A left off. Otherwise, the video agent 16 can handle the process through appropriate interaction with content server 14B. Accordingly, content server 14B will begin streaming Program A to the video agent 16 (step 138).

As illustrated above, the VoD server manager 22 plays an active role in monitoring the status of the active content servers 14, or their relative abilities to deliver the streaming content, and will initiate the switching process in a timely fashion in order to minimize or eliminate any interruption perceived by the subscriber. The VoD server manager 22 may interact with various entities, including the conditional access subsystem 24, to ensure that the content server 14 to which a switching process is taking place has sufficient information to transition to a new content server 14. This information may vary depending on the application, but will generally include any decryption keys and addresses associated with the various content servers 14, as well as the location of the program on the content server 14. Information bearing on where in the program the failure occurred will be obtained by the VoD server manager 22 and passed to the video agent 16, or the video agent 16 and the new content server 14 may cooperate to determine where streaming should begin.

Again, timing is critical in the preferred embodiment. Preferably, the new streaming will be initiated in a short enough period of time to allow the video agent 16 or the associated audio/video system 18 to transition from one content server 14 to another without the subscriber perceiving that there was an interruption, and if such is not possible, minimizing the interruption and eliminating the need for the subscriber to take action to reinitiate the VoD service. The information required to reestablish the VoD service may vary from one network to another. Although the information may vary, the concepts of the present invention are sufficiently broad to cover such variations in information and controlling the various entities from which the information is obtained and delivered.

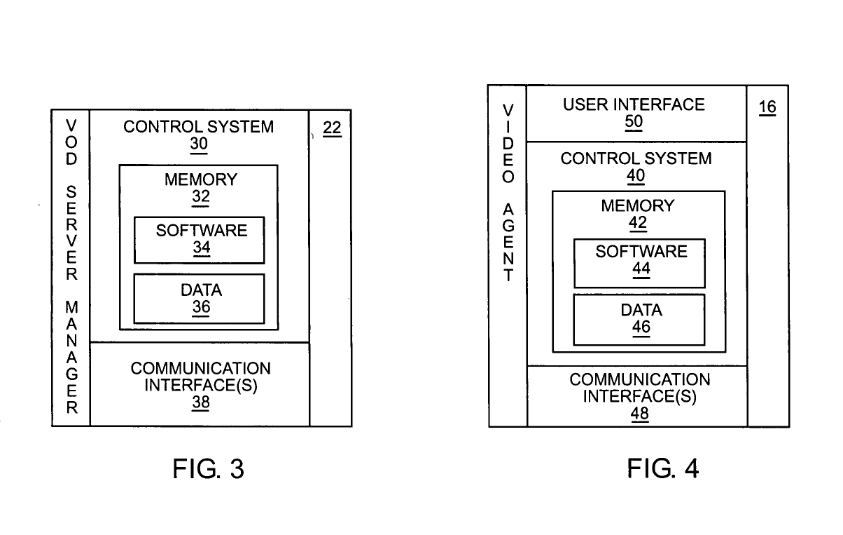

With reference to FIG. 3, a block representation of a VoD server manager 22 is illustrated. The VoD server manager 22 will include a control system 30 having sufficient memory 32 to support the requisite software 34 and data 36 necessary for facilitating the functionality described above. The control system 30 is also associated with one or more communication interfaces 38 to facilitate communications with the various content servers 14, video agent 16, conditional access subsystem 24, middleware server 26, and any other entity with which the VoD server manager 22 must communicate.

With reference to FIG. 4, a video (media) agent 16 is illustrated in a standalone embodiment. The video agent 16 may include a control system 40 having sufficient memory 42 for the requisite software 44 and data 46 to operate as described above. The control system 40 may also be associated with one or more communication interfaces 48, as well as a user interface 50. The communication interface(s) 48 will support communications with the various entities as described above.

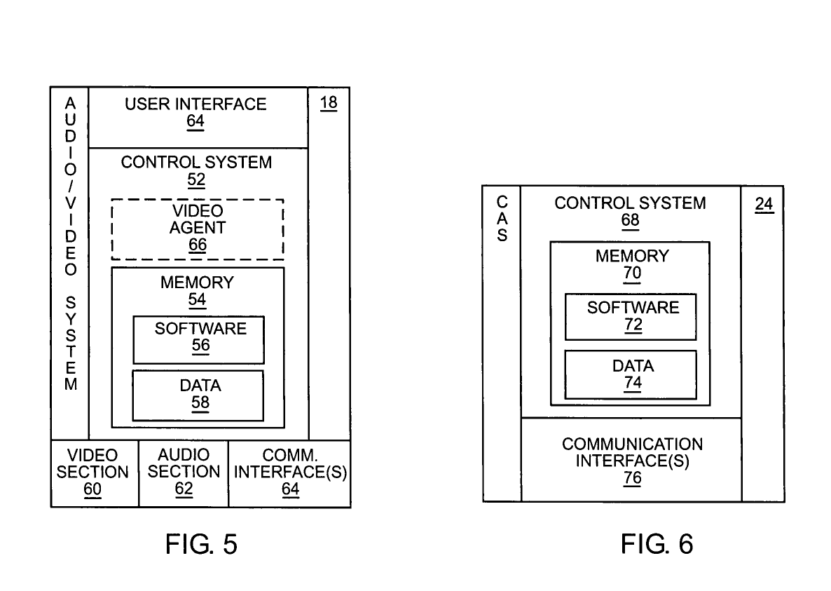

With reference to FIG. 5, an audio/video system 18 is illustrated as having a control system 52 with sufficient memory 54 for the requisite software 56 and data 58 to operate as described above. The control system 52 is also associated with a video section 60, audio section 62, and one or more communication interfaces 64. The video section 60 may include simply the circuitry for displaying video and may also include the requisite display or monitor. Similarly, the audio section 62 may process audio signals and amplify them, as well as including speakers for reproducing audio for the subscriber. The communication interface(s) 64 may provide a connection directly or indirectly to the communication network 12 in a wired or wireless fashion, as well as provide an interface to the video agent 16 through which the audio and video information from the streaming VoD session is received for processing. Alternatively, the control system 52 may implement in hardware or software a logical video agent 66, which will provide all of the requisite functionality of the standalone video agent 16 in the form of a set-top box or cable card.

With reference to FIG. 6, a conditional access subsystem (or server) 24 is illustrated. The conditional access subsystem 24 may include a control system 68 with sufficient memory 70 for the requisite software 72 and data 74 to operate as described above. The control system 68 may also be associated with one or more communication interfaces 76 to facilitate communications with the various network entities.

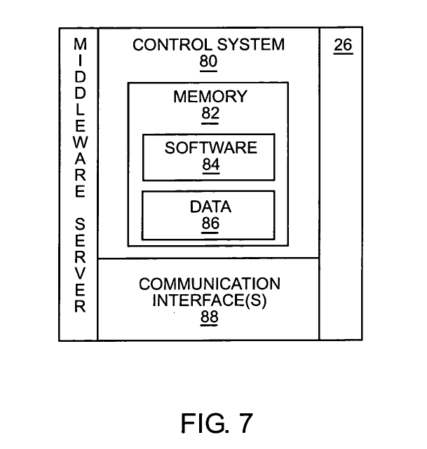

With reference to FIG. 7, a middleware server 26 is illustrated. The middleware server 26 may include a control system 80 having sufficient memory 82 for the requisite software 84 and data 86 to operate as described above. The control system 80 may also be associated with one or more communication interfaces 88 to facilitate communications with the various network entities.

Those skilled in the art will recognize improvements and modifications to the preferred embodiments of the present invention. All such improvements and modifications are considered within the scope of the concepts disclosed herein and the claims that follow.

What is claimed is:

1. A method for handling failures during a media on demand service comprising:
detecting a failure associated with a first streaming media session to a media agent from a first content server for a media on demand service; and
effecting delivery of information to the media agent, the information sufficient to allow the media agent to establish a second streaming media session to the media agent from a second content server for the media on demand service, wherein delivery of the media on demand service switches from the first content server to the second content server upon detecting the failure.

2. The method of claim 1 wherein detecting the failure comprises monitoring a plurality of content servers, which includes the first content server, for a failure associated with streaming media sessions.

3. The method of claim 1 wherein the failure is an actual failure or an indication of an imminent failure.

4. The method of claim 1 wherein the information comprises decryption indicia, which allows the media agent to decrypt the second streaming media session.

5. The method of claim 4 wherein effecting delivery of the information comprises instructing a conditional access entity to provide the decryption indicia to the media agent.

6. The method of claim 1 wherein the information comprises address indicia, which allows the media agent to access content for the second streaming media session on the second content server.

7. The method of claim 6 wherein the address indicia is delivered directly to the media agent from a server manager, which detected the failure and effected delivery of the information.

8. The method of claim 6 wherein the address indicia is an Internet Protocol address associated with the second content server for the second streaming media session on the second content server.

9. The method of claim 1 further comprising:
receiving an availability request for the media on demand service;
determining availability for the media on demand service; and
responding to the availability request in light of the availability of the media on demand service.

10. The method of claim 1 further comprising:
receiving a service request for the media on demand service from the media agent; and
effecting delivery of initial information to the media agent to establish the first streaming media session to the media agent from the first content server for the media on demand service.

11. The method of claim 10 wherein the information comprises decryption indicia, which allows the media agent to decrypt the first streaming media session.

12. The method of claim 10 wherein the information comprises address indicia, which allows the media agent to access content for the first streaming media session on the first content server.

13. The method of claim 1 wherein the media on demand service is a specific program dynamically selected by a subscriber in real time.

14. The method of claim 1 wherein the media on demand service is a video on demand service.

15. The method of claim 1 wherein the media on demand service comprises a defined audio, video, or audio and video segment.

16. The method of claim 1 wherein the media agent resides in an entity at a customer premise.

17. The method of claim 16 wherein the media agent is implemented in a standalone device.

18. The method of claim 16 wherein the media agent is implemented in a set-top box or card.

19. The method of claim 16 wherein the media agent is integrated in an audio/video system.

20. The method of claim 1 wherein the delivery of the media on demand service is switched from the first content server to the second content server within a period of time short enough to prevent an impact on the media on demand service as perceived by a subscriber.

21. The method of claim 1 wherein the delivery of the media on demand service is switched from the first content server to the second content server within a period of time short enough to minimize an impact on the media on demand service as perceived by a subscriber.

22. A media on demand server manager comprising:
a communication interface; and
a control system associated with the communication interface and adapted to:
detect a failure associated with a first streaming media session to a media agent from a first content server for a media on demand service; and
effect delivery of information to the media agent, the information sufficient to allow the media agent to establish a second streaming media session to the media agent from a second content server for the media on demand service, wherein delivery of the media on demand service is switched from the first content server to the second content server upon detecting the failure.
